(19) United States
(12) Patent Application Publication
(10) Pub. No.: US 2025/0346201 A1
(43) Pub. Date: Nov. 13, 2025

(54) Crash Box for a Motor Vehicle

(71) Applicant: Bayerische Motoren Werke Aktiengesellschaft, Muenchen (DE)

(72) Inventor: Rainer RAUCH, Kirchheim /Teck (DE)

(21) Appl. No.: 18/869,340

(22) PCT Filed: Jun. 26, 2023
(86) PCT No.: PCT/EP2023/067293

§ 371 Date: Nov. 26, 2024

(30) Foreign Application Priority Data
Jul. 28, 2022 (DE) 10 2022 118 960.0

(51) Int. Cl. B60R 19/34

(52) U.S. Cl. CPC B60R 19/34

(57) ABSTRACT

A crash box is provided for a motor vehicle having a vehicle longitudinal member which extends in the vehicle longitudinal direction and to the side of which facing away from a passenger compartment of the motor vehicle a rear end of the crash box can be fastened, and having a cross-member which extends in the vehicle width direction and to the side of which facing the passenger compartment of the motor vehicle a front end of the crash box can be fastened. The crash box has a cable which extends along the vehicle longitudinal direction from the front end of the crash box to the rear end of the crash box and is connected to the front end of the crash box and to the rear end of the crash box.

### BACKGROUND AND SUMMARY

The present invention concerns a crash box for a motor vehicle, and a motor vehicle having the crash box.

EP1742818B1 discloses a generic crash box for a motor vehicle, with at least one crash box part which is deformable in the event of a crash and which absorbs energy by the deformation thereof in the case of a crash. The crash box here comprises at least one weakening tool which weakens the entire structure of the at least one crash box so as to set the energy-absorption capacity of the crash box part, whereby the stiffness of the crash box part can be reduced.

As described in DE102011083372A1, it is generally known in motor vehicle construction to fasten a crash box to the front end faces of engine longitudinal members. A front bumper is mounted at the front ends of the crash boxes. To fasten a crash box to such a vehicle longitudinal member, it is known to weld an end plate onto the end faces of the vehicle longitudinal members, such that it protrudes from the vehicle longitudinal member in the form of a collar in the vehicle height direction and in the vehicle transverse direction. A crash box may be bolted onto this end plate.

Bumper systems must cover a wide spectrum of requirement scenarios (e.g. speed, barrier, impact point etc.). The so-called Small Overlap Test leads to locally very high loads in a front-end structure of the motor vehicle. In order to introduce this force over a wider area in this load case, strap bands are conventionally installed along the crossmember, i.e. bands extending along the crossmember in the vehicle transverse direction. This installation position has proved to be not robustly effective. This is because of the great length tolerances of the bands and the difficult fixing of the bands under load in this installation position, i.e. a slight slippage under load.

In this context of the prior art, the object of the present disclosure is to provide a device which is able to improve the prior art.

This object is achieved by the features of the independent claims. The dependent claims concern preferred refinements of the invention.

Accordingly, the object is achieved by a crash box for a motor vehicle. The motor vehicle has a vehicle longitudinal member, which extends in the vehicle longitudinal direction and to which, on the side facing away from a passenger compartment of the motor vehicle, a rear end of the crash box can be fastened, and a crossmember which extends in the vehicle width direction and to which, on the side facing the passenger compartment of the motor vehicle, a front end of the crash box can be fastened.

The crash box has a cable which extends along the vehicle longitudinal direction from a front end of the crash box to a rear end thereof, is connected to the rear end of the crash box, and can be connected to the crossmember.

In other words, a generic crash box or deformation box (“defobox” in brief) for a motor vehicle is provided. The motor vehicle may be a passenger vehicle, in particular a car, and/or a utility vehicle, in particular a truck. This motor vehicle may have a so-called crash management system in a front-end structure, which comprises a crossmember, one or more crash boxes and in some cases further attachments. This crash management system has sufficient flexibility for the so-called Low Speed Crash, since the proposed crash box is not stiffened in comparison with conventional crash boxes by the provision of the cable as the component exclusively absorbing tensile forces. In the load case of the so-called High Speed Crash however, a high strength may be achieved since, by way of the connection of the crash box to the crossmember via the cable, the crash box can be prevented from tearing away from the crossmember. The two requirements, which actually have mutually conflicting objectives, can therefore both be fulfilled with the proposed solution, since it allows avoidance of reinforcing the connection between the crossmember and the deformation box by simply fitting an additional bolt for bolting the crash box directly to the crossmember, which could jeopardize compliance with the load cases of the Low Speed Crash. Also, the proposed connection or fastening by means of the cable prevents, in the so-called Small Overlap Crash, a tearing away of the crossmember from the crash box, which conventionally partially occurs on the side of the motor vehicle facing away from the load. Thus any damage caused to a fuel line mounted at this point by the tearing away of the connection can be prevented.

Possible refinements of the above-described crash box are explained below in detail.

The cable may be arranged, optionally completely, inside the crash box. In other words, the crash box may have a housing via which the crash box can be fastened, optionally bolted, to the longitudinal member and to the crossmember. The cable may be arranged in this housing, wherein the cable may extend along the vehicle longitudinal direction from a front end to a rear end of the crash box housing, and wherein the cable may be connected to the rear end of the crash box housing.

The integration of the cable in the crash box allows secure positioning and guidance of the cable during a crash. The integration in the crash box furthermore means that no additional installation space is required. Thus a compact and space-saving solution may be provided, so that a small clearance remaining in the engine bay at the front-end structure of the motor vehicle is not restricted further. Also, this allows a comparatively simple mounting of the crash box component, since this can be delivered and installed as a single component.

The cable may be connected to the rear end of the crash box via at least one spring element.

The spring element may be configured as a spring clip which is arranged at the rear end of the crash box.

The spring element can generate a pretension of the cable, the amount or value of which can be set or established by selection of a spring constant. Thus component tolerances of the band may be compensated, and the negative effect of cable loosening avoided.

The spring element may be arranged, optionally completely, inside the crash box. This further reinforces the effect described above in relation to the integration of the cable in the crash box.

In other words, the spring element, optionally configured as a spring clip, may be arranged in the above-described crash box housing in addition or alternatively to the cable, wherein the spring element may be fastened to the rear end of the crash box housing.

The cable may be connectable to the crossmember via a connecting element held at the front end of the crash box.

The connecting element may be arranged, optionally completely, inside the crash box.

In other words, the connecting element may be arranged in the above-described crash box housing in addition or alternatively to the cable and/or spring element, wherein the connecting element may be fastened to or can be held at the front end of the crash box housing. This further reinforces the effect described above in relation to the integration of the cable in the crash box.

The connecting element may have an internal thread, so that the crash box can be fastened to the crossmember via a screw connection.

The crash box may be configured to deform in the vehicle longitudinal direction by folding under a force of predefined size acting on the crash box from the front in the vehicle longitudinal direction.

The cable may be a steel cable and/or a plastic cable, optionally a polyester cable.

The invention furthermore concerns a motor vehicle having the above-described crash box, a vehicle longitudinal member which extends in the vehicle longitudinal direction and to which, on the side facing away from a passenger compartment of the motor vehicle, a rear end of the crash box is fastened, and having a crossmember which extends in the vehicle width direction and to which, on the side facing the passenger compartment of the motor vehicle, a front end of the crash box is fastened. The crash box has a cable which extends along the vehicle longitudinal direction from a front end of the crash box to a rear end thereof, is connected to the rear end of the crash box, and can be connected to the crossmember.

The description given above in relation to the crash box also applies accordingly to the motor vehicle, and vice versa.

An embodiment is described below with reference to FIGS. 1 to 4.

### BRIEF DESCRIPTION OF THE DRAWINGS

FIG. 1 shows, schematically and in perspective, an interior or inside of a crash box, mounted on a crossmember, for a motor vehicle;

FIG. 2 schematically shows a top view of the crash box from FIG. 1 alone;

FIG. 3 schematically shows a top view of the crash box from FIGS. 1 and 2 which is mounted on the crossmember;

FIG. 4 shows, schematically and in perspective, a rear end of the crash box from FIGS. 1 to 3 in a first or initial assembly state;

FIG. 5 shows, schematically and in perspective, a rear end of the crash box from FIGS. 1 to 4 in a second assembly state; and

FIG. 6 shows, schematically and in perspective, a rear end of the crash box from FIGS. 1 to 5 in a third or final assembly state.

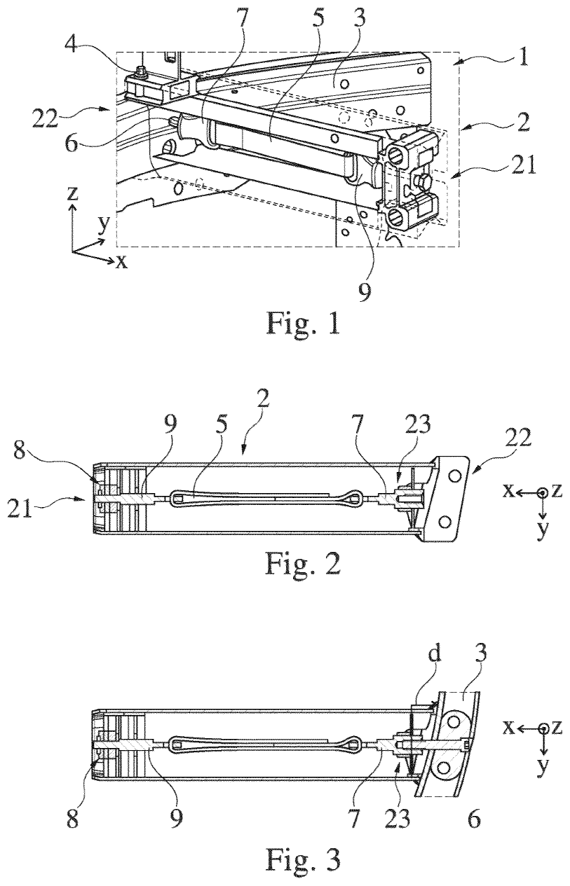

In FIGS. 1 to 6, the same reference signs are used for the same objects, wherein the following description is given in relation to all of FIGS. 1 to 6.

### DETAILED DESCRIPTION OF THE DRAWINGS

In all of FIGS. 1 to 6, a Cartesian coordinate system is shown. The coordinate system comprises an X axis running in the (motor) vehicle longitudinal direction X, a Y axis running in the (motor) vehicle width (transverse) axis Y, and a Z axis running in the (motor) vehicle height direction Z. The X axis runs from a front to a rear of a motor vehicle 1, i.e. opposite to a main travel direction of the motor vehicle 1.

As evident in particular from FIG. 1, the crash box 2 of the motor vehicle 1 (not shown in further detail) can be connected to a vehicle longitudinal member (not shown) extending in a vehicle longitudinal direction X, to which, on the side facing away from a passenger compartment of the motor vehicle 1, a rear end 21 of the crash box can be fastened via two bolts.

As furthermore evident from FIG. 1, the crash box 2 is connected to a crossmember 3 which extends in the vehicle width direction Y and to which, on the side facing the passenger compartment of the motor vehicle 1, a front end 22 of the crash box 2 is fastened, also by means of two bolts 4 (in FIG. 1, only one of these is illustrated or visible).

The crash box 2 has a cable 5 which is arranged completely inside the crash box 2 and extends in the vehicle longitudinal direction X from the front end 22 to the rear end 21 of the crash box 2. In the present case, the cable 5 is configured as a plastic cable, wherein a steel cable is also usable.

Notwithstanding the cable 5, the crash box 2 is configured as a conventional crash box so as to deform in the vehicle longitudinal direction X by folding under a force of predefined size acting from the vehicle longitudinal direction X via the crossmember onto the crash box 2 from the front.

As evident in particular from FIGS. 2 and 3, the cable 5 is connected to the rear end 21 of the crash box 2 and held on the front end 22 of the crash box 2 via a stop 23 and a connecting element 7, which is connected to the cable 5 and also arranged inside the crash box 2. Furthermore, at the front end 22 of the crash box 2, the cable 5 is connected or fastened to the crossmember 3 via a bolt 6, wherein for this the connecting element 7 has an internal thread in which the bolt 6 engages.

The cable 5 is in this case connected to the rear end 21 of the crash box 2 via at least one spring element 8 and hence pretensioned in the crash box 2, wherein the spring element 8, as evident in particular from FIG. 6, takes the form of a spring clip 81. The spring clip 81 can compensate for length tolerances in the vehicle longitudinal direction X, and can ensure a tolerance (or so-called joining gap) on mounting of the crash box 2 on the crossmember 3, as evident in particular from FIG. 3.

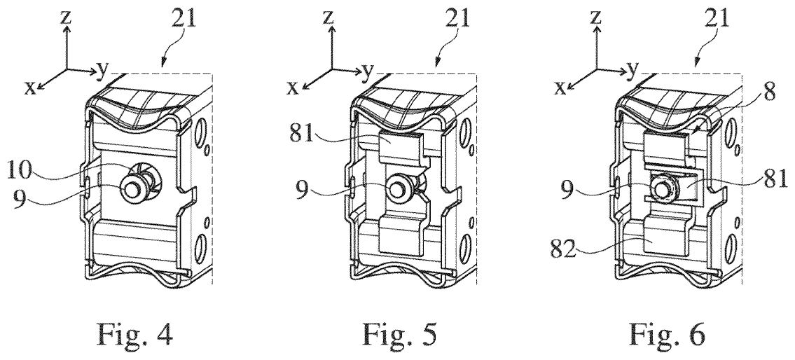

On assembly of the crash box 2, a rear connecting element 9, which is connected to a rear end of the cable 5, is firstly conducted through a passage hole 10 in the rear end 21 of the crash box 2 (see FIG. 4). Then, a clamp 82 is inserted at the side, in order to hold the connecting element 9 and hence the cable 5 on the rear end 21 of the crash box 2 (see FIG. 5). In a final step, the spring clip 81 is pushed, also from the side, between the clamp 82 and the connecting element 9 so that the pretension is created (see FIG. 6).

To summarize, an integration of a so-called Small Overlap Band (see above) in the crash box (in the vehicle longitudinal direction) is thus proposed, in order in the High Speed Crash to transmit the high tensile forces into the system so as to avoid the crossmember tearing away from the crash box. The Small Overlap Band does not however transmit compressive forces, and therefore with this installation position does not influence the properties in the Low Speed Crash.

Thus an optimally compact integration of a catch strap for compliance with Small Overlap requirements in the crash is proposed.

### LIST OF REFERENCE SIGNS

1 Motor vehicle
2 Crash box
21 Rear end of crash box
22 Front end of crash box
23 Stop for holding the cable on the front end of the crash box
3 Crossmember
4 Bolt for connecting the crash box to the crossmember
5 Cable
6 Bolt for fastening the cable to the crossmember
7 Front connecting element for fastening the cable to the crossmember
8 Spring element
81 Spring clip
82 Clamp
9 Rear connecting element for fastening the cable to the rear end of the crash box
10 Passage hole at rear end of crash box
X Vehicle longitudinal direction
Y Vehicle width direction
Z Vehicle height direction

1.-9. (canceled)

10. A crash box for a motor vehicle having a vehicle longitudinal member which extends in a vehicle longitudinal direction and having a crossmember which extends in a vehicle width direction, comprising:
a rear end and a front end of the crash box, wherein on a side of the longitudinal member facing away from a passenger compartment of the motor vehicle, the rear end of the crash box is fastenable, and on a side of the crossmember which faces the passenger compartment, the front end of the crash box is fastenable;
a cable which extends along the vehicle longitudinal direction from the front end of the crash box to the rear end of the crash box, is connected to the rear end of the crash box, and is connectable to the crossmember; and
at least one spring element by which the cable is connected to the rear end of the crash box.

11. The crash box according to claim 10, wherein the cable is arranged inside the crash box.

12. The crash box according to claim 10, wherein the spring element is configured as a spring clip which is arranged at the rear end of the crash box.

13. The crash box according to claim 10, wherein
the cable is connectable to the crossmember via a connecting element held at the front end of the crash box.

14. The crash box according to claim 13, wherein the connecting element is arranged inside the crash box.

15. The crash box according to claim 13, wherein
the connecting element has an internal thread, so that the crash box is fastenable to the crossmember via a screw connection.

16. The crash box according to claim 10, wherein
the crash box is configured to deform in the vehicle longitudinal direction by folding under a force of predefined size acting on the crash box from the front in the vehicle longitudinal direction.

17. The crash box according to claim 10, wherein the cable is a steel cable and/or a plastic cable.

18. A vehicle, comprising:
a crash box;
a vehicle longitudinal member which extends in the vehicle longitudinal direction and to which, on the side facing away from the passenger compartment of the motor vehicle, a rear end of the crash box is fastened; and
a crossmember which extends in the vehicle width direction and to which, on the side facing the passenger compartment of the motor vehicle, a front end of the crash box is fastened,
wherein the crash box has a cable which extends along the vehicle longitudinal direction from the front end of the crash box to the rear end thereof, is connected to the rear end of the crash box, and is connected to the crossmember, and
wherein the cable is connected to the rear end of the crash box via at least one spring element.
